(19) United States
(12) Patent Application Publication
(10) Pub. No.: US 2026/0062312 A1
(43) Pub. Date: Mar. 5, 2026

(54) METHOD OF PREPARING AMORPHOUS IRON SULFIDE CARRIER FOR REMOVING NITROGEN FROM WATER

(71) Applicant: E & CHEM SOLUTION CORP., Gyeonggi-do (KR)

(72) Inventors: Shin-Dong KIM, Gyeonggi-do (KR); Jae-Myung LEE, Gyeonggi-do (KR); Ga-Hwi KIM, Gyeonggi-do (KR); Jae-Chul SHIN, Gyeonggi-do (KR); Min-Ju LEE, Gyeonggi-do (KR); Sang-Eun OH, Gangwon-do (KR); Seung-Gyu KIM, Gangwon-do (KR)

(21) Appl. No.: 19/105,872

(22) PCT Filed: Aug. 23, 2023
(86) PCT No.: PCT/KR2023/012460

§ 371 Date: Feb. 24, 2025

(30) Foreign Application Priority Data
Aug. 22, 2022 (KR) 10-2022-0106001

(51) Int. Cl. C01G 49/12; C02F 3/00; C02F 3/28; C02F 101/16

(52) U.S. Cl. CPC C01G 49/12; C02F 3/2806; C01P 2002/02; C01P 2002/85; C01P 2004/03; C02F 2003/001; C02F 2101/163; C02F 2101/166

(57) ABSTRACT

A method of preparing an amorphous iron sulfide carrier for removing nitrogen from water, which effectively removes nitrogen from wastewater containing nitrate nitrogen or nitrite nitrogen, includes the stabilizing step for an hydrogen sulfide saturated-iron hydroxide material by immersing the material in water for a certain period of time, a step (S10) of preparing iron hydroxide for hydrogen sulfide adsorption having pores and a surface capable of adsorbing hydrogen sulfide; a step (S20) of introducing hydrogen sulfide into the prepared iron hydroxide to reach the iron hydroxide and produce amorphous iron sulfide; and a step (S30) of stabilizing the amorphous iron sulfide produced by reacting with hydrogen sulfide, by immersing in water for one or more days.

### TECHNICAL FIELD

The present invention relates to a method of preparing an amorphous iron sulfide carrier that effectively removes nitrogen from wastewater containing nitrate or nitrite. This method involves stabilizing an iron hydroxide-based adsorbent that has undergone breakthrough point due to hydrogen sulfide by immerging it in water for a certain period, thereby enabling its conversing into an amorphous iron sulfide carrier.

BACKGROUND ART

Advanced wastewater treatment technology is a technology to efficiently remove nitrogen (N) and phosphorus (P), which are the main causes of eutrophication in rivers and lakes and are not removed by the activated sludge method. There are biological methods using microorganisms, physical methods such as selective ion exchange, ammonia stripping, break-point chlorine injection, and electrical injection, and chemical methods such as the method using iron hydroxide.

Recently, research is being actively conducted to address the high nitrogen content problem in the rejected water process of the sludge treatment system at sewage treatment plants, the extreme eutrophication of rivers and lakes, and the problem of nitrate nitrogen in wastewater that is harmful to the human body. The sources of nitrogen pollution include human and livestock excrement, sewage, industrial wastewater, agricultural wastewater from compost and fertilizer, nitrogen generated from sludge in lakes and rivers, and nitrogen contained in landfill leachate. The nitrogen is present in the form of inorganic substances, such as ammonia, and organic substances, such as urea and proteins.

Nitrate nitrogen, which is generated by the oxidation of ammonia nitrogen, is harmful to the human body in itself, and when water contaminated with nitrate nitrogen is consumed, it is absorbed into the body and reacts with hemoglobin in the blood. Then, nitrate nitrogen is reduced to nitrite nitrogen, which oxidizes hemoglobin and reduces its oxygen binding capacity. In particular, when infants continue to drink water containing more than 10 mg/L of nitrate nitrogen, it can cause cyanosis, in which the body's color turns blue.

As described above, nitrate nitrogen and nitrite nitrogen, which are harmful to the human body and the environment, denitrification methods that may be used to treat nitrate nitrogen are being developed.

A nitrate nitrogen treatment method that has been widely used is a biological method or Heterotrophic denitrification method. However, due to the close relationship between the denitrification efficiency by microorganisms and the supply of carbon sources in the denitrification process, an external carbon source is required when the internal carbon source is insufficient, so it has an economic problem that an external carbon source must be continuously supplied. In addition, physical methods such as selective ion exchange and ammonia stripping do not denitrify nitrate nitrogen and nitrite nitrogen in wastewater into nitrogen; rather, they are only a preemptive defensive measure to prevent contamination with nitrate nitrogen and nitrite nitrogen in water and are not actual denitrification methods.

Recently, sulfur-based autotrophic denitrification using sulfur is drawing attention, as it does not require an external organic carbon source, is operated under low dissolved oxygen concentration conditions (approximately 0.2 mg/L), and produces little sludge. Sulfur-based denitrification is a denitrification reaction that occurs when sulfur-oxidizing microorganisms such as Thiobacillus denitrificans use inorganic carbon such as HCO₃⁻ as a carbon source and nitrate nitrogen as a final acceptor, and SO₄²⁻ is produced as a final by-product from the sulfur-based denitrification reaction (Scheme 1). In particular, it is known that sulfur-based denitrification have the advantages that a large reactor volume is not necessary and high denitrification efficiency can be obtained with a short residence time.

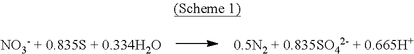

Korean Patent No. 10-1769200, “Biological Nitrogen Removal Apparatus for Treating Wastewater,” provides a method for performing a sulfur-based denitrification process by controlling the flow rates of water within a block-shaped biofilm.

The sulfur-based denitrification process using biofilm block disclosed in Korean Patent No. 10-1769200 has the problem that it is inconvenient to fill the filling material in the form of a mixture of granular activated carbon and granular sulfur, and that the manufacturing process is complicated and requires costs.

### SUMMARY OF THE INVENTION

An object of the present invention is to provide a method of preparing an amorphous iron sulfide carrier for autotrophic denitrification process to remove nitrogens from water.

### TECHNICAL SOLUTION

The method of preparing an amorphous iron sulfide carrier for removing nitrogen from water according to the present invention includes: a step (S10) of preparing iron hydroxide for hydrogen sulfide adsorption having pores and a surface capable of adsorbing hydrogen sulfide; a step (S20) of introducing hydrogen sulfide into the prepared iron hydroxide to reach the iron hydroxide and produce amorphous iron sulfide; and a step (S30) of stabilizing the amorphous iron sulfide produced by reacting with hydrogen sulfide, by immersing in water for one or more days.

Preferably, the iron hydroxide for hydrogen sulfide adsorption is produced by adding caustic soda (NaOH) or liquid slaked lime (Ca(OH)₂) to acidic mine drainage and mixing an inorganic binder.

Preferably, the immersing period in the stabilizing step is one or two days.

Preferably, the iron hydroxide for hydrogen sulfide adsorption is placed in a reaction tower, and an odorous gas containing hydrogen sulfide is injected to introduce hydrogen sulfide into the iron hydroxide.

### ADVANTAGEOUS EFFECTS

The amorphous iron sulfide carrier for removing nitrogen from water of the present invention is excellent in denitrifying nitrate nitrogen and nitrite nitrogen contained in wastewater and can effectively remove nitrogen.

In addition, since iron hydroxide that removes hydrogen sulfide can be recycled, iron sulfide for sulfur-based denitrification can be prepared economically.

In addition, by producing iron hydroxide from iron salt or acidic mine drainage and producing amorphous iron sulfide therefrom, there is an advantage in that environmental pollution caused by discarded acidic mine drainage can be prevented.

### BRIEF DESCRIPTION OF DRAWINGS

FIG. 1 shows a process diagram of the method of preparing an amorphous iron sulfide carrier for removing nitrogen from water according to the present invention;

FIG. 2A shows a scanning electron microscope (SEM) photograph of the amorphous iron sulfide carrier for removing nitrogen from water according to Manufacturing Example 2 of the present invention;

FIG. 2B shows a graph illustrating the analytical results of energy dispersive X-ray spectrometry (EDS) for the amorphous iron sulfide carrier for removing nitrogen from water according to Manufacturing Example 2 of the present invention;

FIG. 2C shows a graph illustrating the analytical results of element content from EDS for the amorphous iron sulfide carrier for removing nitrogen from water according to Manufacturing Example 2 of the present invention;

FIG. 3 shows a graph illustrating the results of an experiment on the breakthrough of biological nitrate nitrogen by the amorphous iron sulfide carrier for removing nitrogen from water according to the present invention;

FIG. 4 shows a graph illustrating the analysis of the elution amount of biological sulfate from the amorphous iron sulfide carrier for removing nitrogen from water according to the present invention;

FIG. 5 shows a graph of an electrical conductivity analysis of the amorphous iron sulfide carrier for removing nitrogen from water according to the present invention; and

FIG. 6 shows a graph of a chloride ion analysis of the amorphous iron sulfide carrier for removing nitrogen from water according to the present invention.

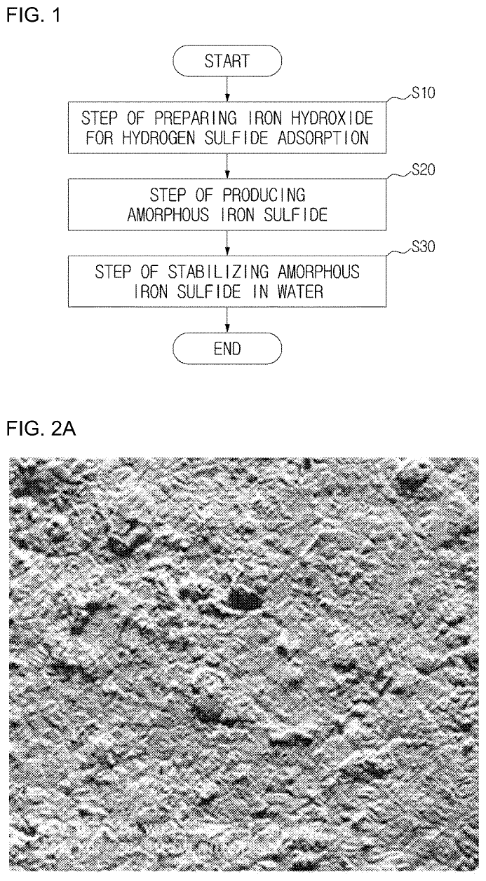

### DETAILED DESCRIPTION OF THE INVENTION

Hereinafter, the present invention will be described in more details.

The method of preparing an amorphous iron sulfide carrier for removing nitrogen from water according to the present invention includes: a step (S10) of preparing iron hydroxide for hydrogen sulfide adsorption; a step (S20) of producing amorphous iron sulfide; and a step (S30) of stabilizing the amorphous iron sulfide in water.

In the step (S10) of preparing iron hydroxide for hydrogen sulfide adsorption, iron hydroxide having pores and a surface capable of adsorbing hydrogen sulfide is prepared. At this time, the iron hydroxide for hydrogen sulfide adsorption is preferably produced by adding caustic soda (NaOH) or liquid slaked lime (Ca(OH)₂) to acidic mine drainage containing a large amount of iron salt or iron component, and mixing an inorganic binder. When caustic soda or liquid slaked lime is added to acidic mine drainage, iron compounds present in the acidic mine drainage are precipitated as iron hydroxide such as FeO(OH) or Fe(OH)₃, and the precipitated iron hydroxide may be formed into pellets or the like to produce an iron hydroxide adsorbent for hydrogen sulfide adsorption.

In the step (S20) of producing amorphous iron sulfide, hydrogen sulfide is introduced into the prepared iron hydroxide to reach the iron hydroxide, thereby producing amorphous iron sulfide. At this time, when iron hydroxide for hydrogen sulfide adsorption is placed in a reaction tower, and a biogas or odorous gas containing hydrogen sulfide is injected, it reacts with the iron components on the pores and surface of the iron hydroxide to produce amorphous iron sulfide. In particular, an odorous gas containing hydrogen sulfide may be preferably used. This allows to produce amorphous iron sulfide while also removing hydrogen sulfide contained in the biogas.

In the step (S30) of stabilizing the amorphous iron sulfide in water, the amorphous iron sulfide produced by the reaction with hydrogen sulfide is stabilized immersing it in water for several days or more. At this time, the immersion period is preferably one to two days. When the amorphous iron sulfide undergoes this immersion process, ions contained in the amorphous iron sulfide such as high-concentration chloride ions, which may cause biological inhibition, may be reduced. Since the amorphous iron sulfide that has completed the stabilization step is chemically very stable, it may be used as an iron sulfide carrier for sulfur-based denitrification.

### Manufacturing Example 1

Iron hydroxide was placed in a reaction tower, and a biogas containing hydrogen sulfide was injected to produce iron sulfide through a chemical reaction between hydrogen sulfide present in the biogas and iron hydroxide (Fe(OH)₃), and the obtained iron sulfide was immersed in water for one day and then dried to produce an amorphous iron sulfide carrier for removing nitrogen from water.

### Manufacturing Example 2

Iron hydroxide was placed in a reaction tower, and an odorous gas containing hydrogen sulfide was injected to produce iron sulfide through a chemical reaction between hydrogen sulfide present in the odorous gas and iron hydroxide (Fe(OH)₃), and the obtained iron sulfide was immersed in water for one day and then dried to produce an amorphous iron sulfide carrier for removing nitrogen from water.

### Experimental Example 1: Experiment for Confirming Amorphous Iron Sulfide

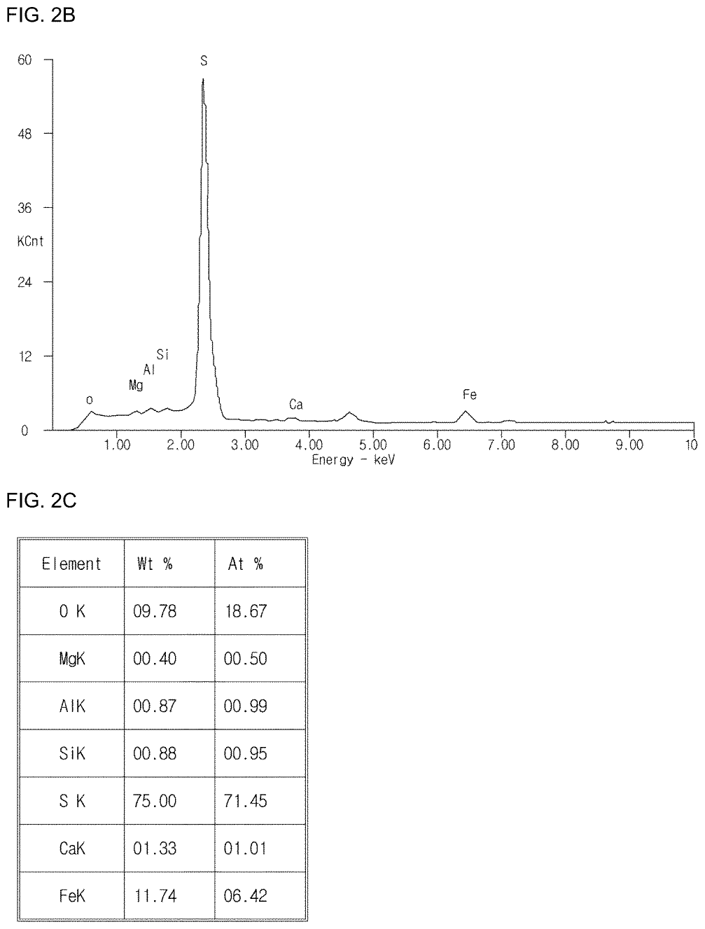

The amorphous iron sulfide carrier for removing nitrogen from water produced by Manufacturing Example 2 was analyzed using a scanning electron microscope (SEM) and an energy dispersive spectrometer (EDS), and the results are shown in the photograph and analytical results of FIG. 2.

As shown in FIG. 2A, it was confirmed that the amorphous iron sulfide carrier for removing nitrogen from water produced by Manufacturing Example 2 was amorphous iron sulfide, and it was confirmed from the graph of FIG. 2B and the elements of FIG. 2C that a large amount of elemental sulfur was present on the surface.

### Experimental Example 2: Experiment for Biological Breakthrough of Nitrate Nitrogen

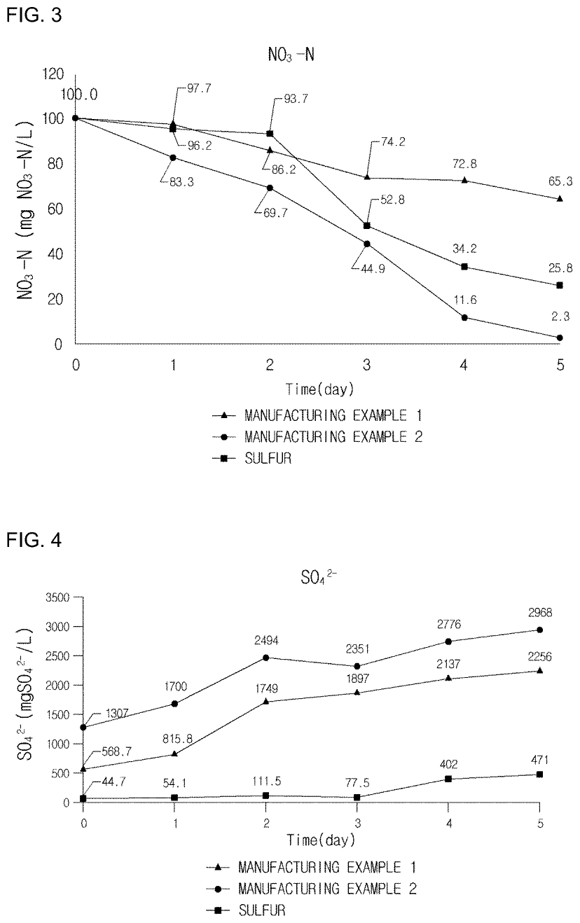

The breakthrough rate of nitrate nitrogen was measured for the amorphous iron sulfide carrier for removing nitrogen from water produced by Manufacturing Examples 1 and 2. 200 mL of the amorphous iron sulfide carrier for removing nitrogen from water produced by Manufacturing Examples 1 and 2 and nitrate nitrogen were injected into a batch reactor, and the breakthrough rate of nitrate nitrogen was measured at a temperature of 30° C., and the results are shown as a graph in FIG. 3. The initial nitrate nitrogen concentration was 100 mg/L, and the composition of the medium was 2 g/L Na₂HPO₄, 2 g/L KH₂PO₄, 0.2 g/L NaHCO₃, 0.1 g/L NH₄Cl, 0.05 g/L MgSO₄, and 5 ml/L trace minerals, and 1.0 mL of sewage treatment plant return sludge and 1.0 mL of thiosulfate-utilizing denitrifying bacterium (TUDB), a sulfur-based denitrification microorganism, were inoculated. 200 mL of sulfur particles were used as a control.

As shown in the graph of FIG. 3, it was confirmed that the amorphous iron sulfide carrier for removing nitrogen from water produced by Manufacturing Examples 1 and 2 could remove nitrate nitrogen. In particular, the amorphous iron sulfide carrier for removing nitrogen from water produced by Manufacturing Example 2 showed a nitrate nitrogen removal rate of 97.7% or higher after five days, and the sulfur particles, which were the control, exhibited a removal rate of 74.2% under the same conditions.

### Experimental Example 3: Experiment on Sulfate Elution Amount of Amorphous Iron Sulfide

When sulfur-based denitrification occurs biologically, sulfate is generated. In order to confirm the amount of sulfate eluted from the amorphous iron sulfide carrier for removing nitrogen from water, the amount of sulfate eluted from the amorphous iron sulfide carrier for removing nitrogen from water produced by Manufacturing Examples 1 and 2 was confirmed, and the results are shown as a graph in FIG. 4. The amount of eluted sulfate was confirmed using sulfur particles as a control group.

As shown in FIG. 4, the amount of sulfate eluted from the amorphous iron sulfide carrier for removing nitrogen from water produced by Manufacturing Example 2, calculated as the difference of the amount of sulfate in the carrier from the initial amount of sulfate after five days, was 1,661 mg/L, indicating that 16.9 mg SO₄²⁻/mg N of sulfate was eluted per unit amount of nitrogen. In the case of sulfur particles, it was confirmed that the amount of eluted sulfate was 416 mg/L, indicating that 5.7 mg SO₄²⁻/mg N of sulfate was eluted.

### Experimental Example 4: Experiment to Confirm the Electrical Conductivity of Amorphous Iron Sulfide

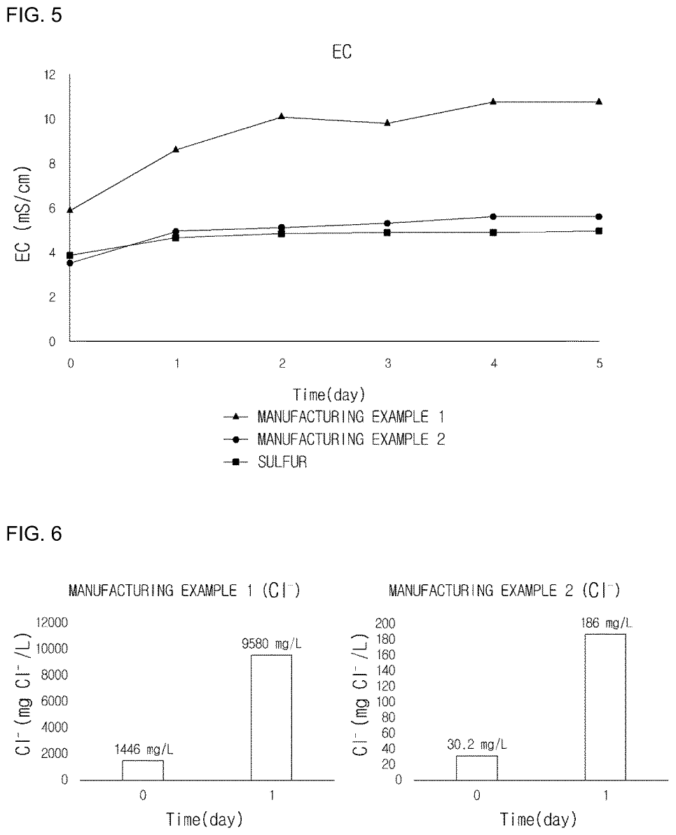

In order to confirm the reactivity when the amorphous iron sulfide carrier for removing nitrogen from water was immersed in water, the electrical conductivity (EC) of the amorphous iron sulfide carrier for removing nitrogen from water produced by Manufacturing Examples 1 and 2 was confirmed, and the results are shown as a graph in FIG. 5. As a control, the EC of sulfur particles was confirmed.

As shown in FIG. 5, it was confirmed that the EC was relatively high in Manufacturing Examples 1 and 2, indicating that ions such as sulfate were dissolved in the solution.

### Experimental Example 5: Experiment to Confirm Chloride Ion (Cl⁻) of Amorphous Iron Sulfide

To verify biological stability, the amount of chloride ion (Cl⁻) generated when the amorphous iron sulfide was immersed in water was confirmed. The amorphous iron sulfide carriers for removing nitrogen from water produced in Manufacturing Examples 1 and 2 were immersed in a batch reactor, and the chloride ion (Cl⁻) after one day was confirmed, and the results are shown as a graph in FIG. 6. At this time, the initial chloride ion (Cl⁻) in the batch reactor in which the amorphous iron sulfide carrier for removing nitrogen from water of Manufacturing Example 1 was immersed was 1,446 mg/L, and the initial chloride ion (Cl⁻) in the batch reactor in which the amorphous iron sulfide carrier for removing nitrogen from water of Manufacturing Example 2 was immersed was 30.2 mg/L.

As shown in FIG. 6, it was confirmed that chloride ion (Cl⁻) was generated in the amorphous iron sulfide carriers for removing nitrogen from water of Manufacturing Examples 1 and 2 while they were used in water. Therefore, it was confirmed that the carriers may be preferably used after immersing them in water for one or two days in order to minimize bio-inhibition. At this time, since the chloride ion (Cl⁻) generation of the amorphous iron sulfide carrier for removing nitrogen from water of Manufacturing Example 2 prepared from an odorous gas was less than the chloride ion (Cl⁻) generation of the amorphous iron sulfide carrier for removing nitrogen from water of Manufacturing Example 1 prepared from a biogas, it was confirmed that the amorphous iron sulfide carrier of Manufacturing Example 2 is better for removing nitrogen from water.

The reason why the amount of eluted sulfate was so much was because the sulfur-based denitrification microorganism uses nitrate nitrogen as the final acceptor, thereby increasing sulfate as a final byproduct. Also, it is considered a large amount of sulfate contained in the amorphous iron sulfide carrier for removing nitrogen from water of the present invention was eluted into the water. To prevent sulfate elution from the amorphous iron sulfide carrier of the present invention, the carrier may be preferably eluted sulfate in a pretreatment and utilized for sulfur-based denitrification. In addition, in the case of the amorphous iron sulfide carrier for removing nitrogen from water, it is judged that the iron sulfide carrier generated from hydrogen sulfide contained in an odorous gas rather than a biogas was a better carrier for sulfur-based denitrification.

As described above, although the present invention has been described by means of limited examples and drawings, the present invention is not limited thereto, and it is obvious that various changes and modifications are possible by a person skilled in the art to which the present invention pertains within the technical idea of the present invention and the scope of equivalents of the claims to be described below.

1. A method of preparing an amorphous iron sulfide carrier for removing nitrogen from water, the method comprising:
a step (S10) of preparing iron hydroxide for hydrogen sulfide adsorption having pores and a surface capable of adsorbing hydrogen sulfide;
a step (S20) of introducing hydrogen sulfide into the prepared iron hydroxide to reach the iron hydroxide and produce amorphous iron sulfide; and
a step (S30) of stabilizing the amorphous iron sulfide produced by reacting with hydrogen sulfide, by immersing in water for one or more days.

2. The method of preparing an amorphous iron sulfide carrier for removing nitrogen from water according to claim 1, wherein the iron hydroxide for hydrogen sulfide adsorption is produced by adding caustic soda (NaOH) or liquid slaked lime (Ca(OH)₂) to acidic mine drainage and mixing an inorganic binder.

3. The method of preparing an amorphous iron sulfide carrier for removing nitrogen from water according to claim 1, wherein the immersing period in the stabilizing step is one or two days.

4. The method of preparing an amorphous iron sulfide carrier for removing nitrogen from water according to claim 1, wherein the iron hydroxide for hydrogen sulfide adsorption is placed in a reaction tower, and an odorous gas containing hydrogen sulfide is injected to introduce hydrogen sulfide into the iron hydroxide.
